(19) United States
(12) Patent Application Publication
(10) Pub. No.: US 2024/0352257 A1
(43) Pub. Date: Oct. 24, 2024

(54) HIGH STRUCTURE CARBON BLACK FOR ENERGY STORAGE AND CONVERATION APPLICATIONS

(71) Applicant: BIRLA CARBON U.S.A., INC., Marietta, GA (US)

(72) Inventor: Zachary A. Combs, Marietta, GA (US)

(21) Appl. No.: 18/685,567

(22) PCT Filed: Aug. 23, 2022
(86) PCT No.: PCT/US2022/041215

§ 371 Date: Feb. 22, 2024

Related U.S. Application Data
(60) Provisional application No. 63/236,153, filed on Aug. 23, 2021.

(51) Int. Cl. C09C 1/48; H01M 4/02; H01M 4/62; H01M 10/0525

(52) U.S. Cl. CPC C09C 1/48; H01M 4/625; H01M 10/0525; C01P 2004/51; C01P 2004/62; C01P 2006/12; C01P 2006/19; C01P 2006/40; C01P 2006/82; H01M 2004/027

(57) ABSTRACT

High structure carbon black, methods for preparing same, and energy storage and conversion devices comprising same.

### CROSS-REFERENCE TO RELATED APPLICATIONS

This application claims priority to U.S. Provisional Application No. 63/236,153, filed Aug. 23, 2021, the entirety of which is incorporated into this application by reference.

### BACKGROUND

### Technical Field

The present disclosure relates to carbon black materials, and specifically to high structure carbon black materials, together with methods of making and using such carbon black materials, particularly in energy storage and conversion applications, e.g., as a conductive layer or additive of an anode.

### Technical Background

Carbon black materials can be utilized in a variety of applications to impart desirable properties to polymeric materials. In various aspects, carbon black materials can impart electrical properties, such as, for example, increased conductance or increased resistivity to materials in which they are incorporated. Conductive carbon blacks can be used in a variety of application, including batteries. There is a need for improved high structure carbon black for energy storage and conversion devices. These needs and other needs are satisfied by the compositions and methods of the present disclosure.

### SUMMARY

In accordance with the purpose(s) of the invention, as embodied and broadly described herein, this disclosure, in one aspect, relates to carbon black materials, and specifically to high structure carbon black materials.

In one aspect, the disclosed carbon black has the following properties when in powdered form: a nitrogen surface area (NSA) ranging from about 45 m²/g to about 75 m²/g; a statistical thickness surface area (STSA) ranging from about 45 m²/g to about 75 m²/g; an oil absorption number ranging from about 175 cc/100 g to about 275 cc/100 g; and a compressed oil absorption number (COAN) ranging from about 85 cc/100 g to about 135 cc/100 g.

In a further aspect, the disclosed carbon black has the following properties when in beaded form: a nitrogen surface area (NSA) ranging from about 45 m²/g to about 75 m²/g; a statistical thickness surface area (STSA) ranging from about 40 m²/g to about 75 m²/g; an oil absorption number ranging from about 130 cc/100 g to about 220 cc/100 g; and a compressed oil absorption number (COAN) ranging from about 75 cc/100 g to about 135 cc/100 g.

Also disclosed are electrodes and energy storage devices comprising the inventive carbon blacks, for example as conductive additives or anode active materials. Suitable devices include capacitors, batteries, and the like.

Additional aspects of the invention will be set forth in part in the description which follows, and in part will be obvious from the description, or can be learned by practice of the invention. The advantages of the invention will be realized and attained by means of the elements and combinations particularly pointed out in the appended claims. It is to be understood that both the foregoing general description and the following detailed description are exemplary and explanatory only and are not restrictive of the invention, as claimed.

### BRIEF DESCRIPTION OF THE DRAWINGS

The accompanying figures, which are incorporated in and constitute a part of this specification, illustrate several aspects and together with the description serve to explain the principles of the invention.

FIG. 1 shows plots of aggregate size distribution for two exemplary carbon blacks, Birla Carbon BCD9110 and C7055U.

FIG. 2 shows a plot of void volume versus mean pressure for two exemplary carbon blacks, Birla Carbon BCD9110 and C7055U, showing the void volume of BCD9110 to be higher than C7055U.

### DESCRIPTION

The present invention can be understood more readily by reference to the following detailed description of the invention and the Examples included therein.

Before the present compounds, compositions, articles, systems, devices, and/or methods are disclosed and described, it is to be understood that they are not limited to specific synthetic methods unless otherwise specified, or to particular reagents unless otherwise specified, as such can, of course, vary. It is also to be understood that the terminology used herein is for the purpose of describing particular aspects only and is not intended to be limiting. Although any methods and materials similar or equivalent to those described herein can be used in the practice or testing of the present invention, example methods and materials are now described.

All publications mentioned herein are incorporated herein by reference to disclose and describe the methods and/or materials in connection with which the publications are cited.

Unless defined otherwise, all technical and scientific terms used herein have the same meaning as commonly understood by one of ordinary skill in the art to which this invention belongs. Although any methods and materials similar or equivalent to those described herein can be used in the practice or testing of the present invention, example methods and materials are now described.

As used herein, unless specifically stated to the contrary, the singular forms “a,” “an” and “the” include plural referents unless the context clearly dictates otherwise. Thus, for example, reference to “a filler” or “a solvent” includes mixtures of two or more fillers, or solvents, respectively.

Ranges can be expressed herein as from “about” one particular value, and/or to “about” another particular value. When such a range is expressed, another aspect includes from the one particular value and/or to the other particular value. Similarly, when values are expressed as approximations, by use of the antecedent “about,” it will be understood that the particular value forms another aspect. It will be further understood that the endpoints of each of the ranges are significant both in relation to the other endpoint, and independently of the other endpoint. It is also understood that there are a number of values disclosed herein, and that each value is also herein disclosed as “about” that particular value in addition to the value itself. For example, if the value “10” is disclosed, then “about 10” is also disclosed. It is also understood that each unit between two particular units are also disclosed. For example, if 10 and 15 are disclosed, then 11, 12, 13, and 14 are also disclosed.

When the term “about” precedes a numerical value, the numerical value can vary plus or minus 10% unless stated otherwise.

As used herein, the terms “optional” or “optionally” means that the subsequently described event or circumstance can or can not occur, and that the description includes instances where said event or circumstance occurs and instances where it does not.

Disclosed are the components to be used to prepare the compositions of the invention as well as the compositions themselves to be used within the methods disclosed herein. These and other materials are disclosed herein, and it is understood that when combinations, subsets, interactions, groups, etc. of these materials are disclosed that while specific reference of each various individual and collective combinations and permutation of these compounds can not be explicitly disclosed, each is specifically contemplated and described herein. For example, if a particular compound is disclosed and discussed and a number of modifications that can be made to a number of molecules including the compounds are discussed, specifically contemplated is each and every combination and permutation of the compound and the modifications that are possible unless specifically indicated to the contrary. Thus, if a class of molecules A, B, and C are disclosed as well as a class of molecules D, E, and F and an example of a combination molecule, A-D is disclosed, then even if each is not individually recited each is individually and collectively contemplated meaning combinations, A-E, A-F, B-D, B-E, B-F, C-D, C-E, and C-F are considered disclosed. Likewise, any subset or combination of these is also disclosed. Thus, for example, the sub-group of A-E, B-F, and C-E would be considered disclosed. This concept applies to all aspects of this application including, but not limited to, steps in methods of making and using the compositions of the invention. Thus, if there are a variety of additional steps that can be performed it is understood that each of these additional steps can be performed with any specific embodiment or combination of embodiments of the methods of the invention.

Each of the materials disclosed herein are either commercially available and/or the methods for the production thereof are known to those of skill in the art.

It is understood that the compositions disclosed herein have certain functions. Disclosed herein are certain structural requirements for performing the disclosed functions, and it is understood that there are a variety of structures that can perform the same function that are related to the disclosed structures, and that these structures will typically achieve the same result.

Unless indicated otherwise, parts are parts by weight, temperature is in ° C. or is at ambient temperature, and pressure is at or near atmospheric.

As briefly described above, the present disclosure provides carbon black materials, and specifically high structure carbon black materials. In various aspects, such carbon black materials can impart desirable electrical properties in a certain applications, such as, for example, plastics.

Morphological characteristics of carbon black include, for example, particle size/fineness, surface area, aggregate size/structure, aggregate size distribution, and aggregate shape. Particle size is a measurement of diameter of the primary particles of carbon black. These roughly spherical particles of carbon black have an average diameter in the nanometers range. Particle size can be measured directly via electron microscopy or indirectly by surface area measurement. Average particle size is an important factor that can determine the dispersibility, tensile strength, tear resistance, hysteresis, and abrasion resistance in a rubber article while in liquids and plastics systems, the average particle size can strongly influence the relative color strength, UV stability, and conductivity of the composite. At equal structure, smaller particle size imparts higher tensile strength, tear resistance, hysteresis and abrasion resistance, stronger color, UV resistance, and increased difficulty of dispersion.

Carbon black particles coalesce to form larger clusters or aggregates, which are the primary dispersible units of carbon black. Aggregate size and structure are controlled in the reactor. Measurement of aggregate structure can be obtained from electron microscopy or oil absorption. Structure was historically measured by N-dibutyl phthalate, or DBP, absorption, now replaced by oil absorption number, or OAN (ASTM D2414-18, ISO 4656/1). Another measure of structure is the compressed oil absorption number, or COAN (ASTM D3493-18), where a carbon black sample is mechanically compressed prior to performing the oil absorption measurement. The difference between OAN and COAN values can be an indicator of the stability of the carbon black structure. Grades with relatively large aggregates with a high number of primary particles can be high structure grades, with bulkier aggregates that have more void space and high oil absorption. High structure carbon black can increase electrical conductivity.

The basic method for the production of carbon black is well known. Generally, carbon black is produced by the partial oxidation or thermal decomposition of hydrocarbon gases or liquids, where a hydrocarbon raw material (hereinafter called “feedstock hydrocarbon”) is injected into a flow of hot gas wherein the feedstock hydrocarbon is pyrolyzed and converted into a smoke before being quenched by a water spray. The hot gas is produced by burning fuel in a combustion section. The hot gas flows from the combustion section into a reaction section which is in open communication with the combustion section. The feedstock hydrocarbon is introduced into the hot gas as the hot gas flows through the reaction section, thereby forming a reaction mixture comprising particles of forming carbon black. The reaction mixture flows from the reactor into a cooling section which is in open communication with the reaction section. At some location in the cooling section, one or more quench sprays of, for example, water, are introduced into the flowing reaction mixture thereby lowering the temperature of the reaction mixture below the temperature necessary for carbon black production and halting the carbon formation reaction. The black particles are then separated from the flow of hot gas. A broad range of carbon black types can be made by controlled manipulation of the reactor conditions.

Many carbon black reactors normally comprise a cylindrical combustion section axially connected to one end of a cylindrical or frusto-conical reaction section. A reaction choke is often axially connected to the other end of the reaction section. The reaction choke has a diameter substantially less than the diameter of the reaction section and connects the reaction section to the cooling section. The cooling section is normally cylindrical and has a diameter which is substantially larger than the diameter of the reaction choke.

The carbon black material of the present invention can be made using techniques generally known in the carbon black art. Various methods of making the inventive carbon black are described below and in the Examples. Variations on these methods can be determined by one of skill in the art. In one aspect, the carbon blacks of the present invention can be produced in a carbon black reactor, such as those described generally in U.S. Pat. Nos. 4,927,607 and 5,256,388, the disclosure of which are hereby incorporated by reference in their entireties. Other carbon black reactors can be used, and one of skill in the art can determine an appropriate reactor for a particular application. Feedstock, combustion feeds, and quenching materials are well known in the carbon black art. The choice of these feeds is not critical to the carbon blacks of the present invention. One of skill in the art can determine appropriate feeds for a particular application. The amounts of feedstock, combustion feeds, and quenching materials can also be determined by one of skill in the art which are suitable for a particular application.

It is well known that carbon black exists as a collection of aciniform aggregates that cover a wide range of surface area and structure or absorptive capacity. The absorptive capacity or aggregate structure manifests itself through its impact on viscosity in a polymeric compound, with higher structure driving higher viscosity. More fundamentally and from a morphological standpoint, structure manifests itself through shape and/or the degree of aggregate complexity, with lower structure aggregates having a more compact, spherical and ellipsoidal structure and higher structure aggregates having a more branched and open architecture capable of occluding a significant amount of polymer. In certain aspects, the larger an aggregate size and/or the more branching that exists within an aggregate, the more electrically conductive a composite material will be that incorporates such carbon black.

In one aspect, the methods described herein can provide a conductive composition comprising a highly structure carbon black.

The carbon black of the present invention can comprise any carbon black having an aciniform structure. In one aspect, the filler can comprise a carbon black material. In another aspect, the filler can comprise a conductive or semi-conductive carbon black. In yet another aspect, the filler can comprise a high structure carbon black. In another aspect, the filler can comprise a carbon black having an oil absorption number (OAN), as measured by ASTM D2414, of at least about 220, 225, 230, 235, 240, 245, 250, 255, 260 cc/100 g, or higher. In other aspects, the filler can comprise a carbon black having an oil absorption number of from about 215 to about 240, from about 220 to about 240, from about 220 to about 230, from about 220 to about 250, from about 220 to about 280, from about 230 to about 270, from about 240 to about 260, from about 245 to about 265, from about 250 to about 270, or from about 250 to about 260 cc/100 g. In still other aspects, the carbon black can have an oil absorption number less than or greater than any specific value or range recited herein, and the present invention is not intended to be limited to any particular oil absorption number.

In another aspect, the carbon black can have a compressed oil absorption number (COAN), as measured by ASTM D3493, of from about 90 to about 130, from about 95 to about 125, from about 100 to about 120, from about 105 to about 125, from about 105 to about 115, from about 110 to about 115, from about 100 to about 125, from about 110 to about 115, or from about 110 to about 120 cc/100 g. In still other aspects, the carbon black can have a compressed oil absorption number less than or greater than any specific value or range recited herein, and the present invention is not intended to be limited to any particular compressed oil absorption number.

In various aspects, the carbon black of the present invention can have a nitrogen surface area (NSA) as measured by ASTM D6556, of from about 50 to about 70, from about 55 to about 65, from about 57 to about 65, from 55 to about 62, from about 60 to about 65, or from about 58 to about 64 m2/g. In another aspect, the carbon black has a nitrogen surface area of less than about 65, less than about 64, less than about 63, less than about 62, or less than about 61 m²/g. In still other aspects, the carbon black can have a nitrogen surface area number less than or greater than any specific value or range recited herein, and the present invention is not intended to be limited to any particular nitrogen surface area.

In various aspects, the carbon black of the present invention can have an external surface area, or statistical thickness surface area (STSA), as measured by ASTM D6556, of from about 50 to about 70, from about 55 to about 65, from about 57 to about 65, from 55 to about 62, from about 60 to about 65, or from about 58 to about 64 m²/g. In still other aspects, the carbon black can have a statistical thickness surface area less than or greater than any specific value or range recited herein, and the present invention is not intended to be limited to any particular statistical thickness surface area.

In various aspects, the carbon black of the present invention can have an iodine adsorption number, as measured by ASTM D1510, of from about 50 to about 80, from about 55 to about 70, from about 55 to about 65, from about 57 to about 65, from 55 to about 62, from about 60 to about 65, or from about 58 to about 64 m²/g. In still other aspects, the carbon black can have an iodine adsorption number less than or greater than any specific value or range recited herein, and the present invention is not intended to be limited to any particular iodine adsorption number.

In another aspect, the carbon black can have a ratio of compressed oil absorption number to oil absorption number (i.e., COAN/OAN) ratio of at least about 0.45, least about 0.47, at least about 0.49, at least about 0.51, at least about 0.53, at least about 0.55, at least about 0.57 or more.

In one aspect, the carbon black can have an NSA of from about 55 to about 65, from about 55 to about 60, from about 58 to about 62, or from about 57 to about 61 m²/g, a STSA of from about 55 to about 65, from about 55 to about 60, from about 58 to about 62, from about 55 to about 59, from about 57 to about 60, or from about 57 to about 61 m²/g, an OAN of from about 220 to about 240, from about 215 to about 230, from about 218 to about 228, from about 220 to about 230, or from about 220 to about 225 cm³/100 g, and a COAN of from about 95 to about 115, from about 100 to about 115, from about 105 to about 115, from about 100 to about 120, from about 106 to about 112, or from about 104 to about 114 cm³/100 g.

In one aspect, the carbon black can have an NSA of from about 55 to about 65, from about 55 to about 60, from about 58 to about 62, or from about 57 to about 61 m²/g, a STSA of from about 55 to about 65, from about 55 to about 60, from about 58 to about 62, or from about 57 to about 61 m²/g, and an OAN of from about 240 to about 260, from about 245 to about 260, from about 250 to about 260, from about 248 to about 258, or from about 250 to about 255 cm³/100 g.

In other aspects, the carbon black can have an ash level of less than about 0.5, less than about 0.4, less than about 0.3, less than about 0.2, less than about 0.1, less than about 0.05, less than about 0.04, less than about 0.03, or less than about 0.02 wt. %.

In one aspect, the carbon black, in powdered form, has at least one or all of the following properties: a nitrogen surface area (NSA) ranging from about 45 m²/g to about 75 m²/g; a statistical thickness surface area (STSA) ranging from about 45 m²/g to about 75 m²/g; an oil absorption number ranging from about 175 cc/100 g to about 275 cc/100 g; and a compressed oil absorption number (COAN) ranging from about 85 cc/100 g to about 135 cc/100 g.

In a further aspect, the carbon black, in beaded form, has at least one or all of the following properties: a nitrogen surface area (NSA) ranging from about 45 m²/g to about 75 m²/g; a statistical thickness surface area (STSA) ranging from about 40 m²/g to about 75 m²/g; an oil absorption number ranging from about 130 cc/100 g to about 220 cc/100 g; and a compressed oil absorption number (COAN) ranging from about 75 cc/100 g to about 135 cc/100 g.

In some aspects, the carbon black has at least one of or all of the following properties when in powdered form: a nitrogen surface area (NSA) ranging from about 48 m²/g to about 72 m²/g; a statistical thickness surface area (STSA) ranging from about 46 m²/g to about 70 m²/g; an oil absorption number ranging from about 179 cc/100 g to about 269 cc/100 g; and a compressed oil absorption number (COAN) ranging from about 87 cc/100 g to about 131 cc/100 g.

In a further aspect, the carbon black has at least one of or all of the following properties when in powdered form: a nitrogen surface area (NSA) ranging from about 54 m²/g to about 66 m²/g; a statistical thickness surface area (STSA) ranging from about 52 m²/g to about 64 m²/g; an oil absorption number ranging from about 202 cc/100 g to about 246 cc/100 g; and a compressed oil absorption number (COAN) ranging from about 98 cc/100 g to about 120 cc/100 g.

In a further aspect, the carbon black has at least one of or all of the following properties when in powdered form: a nitrogen surface area (NSA) ranging from about 57 m²/g to about 63 m²/g; a statistical thickness surface area (STSA) ranging from about 55 m²/g to about 61 m²/g; an oil absorption number ranging from about 213 cc/100 g to about 235 cc/100 g; and a compressed oil absorption number (COAN) ranging from about 104 cc/100 g to about 114 cc/100 g.

In another aspect, the carbon black has at least one of or all of the following properties when in beaded form: a nitrogen surface area (NSA) ranging from about 49 m²/g to about 73 m²/g; a statistical thickness surface area (STSA) ranging from about 44 m²/g to about 66 m²/g; an oil absorption number ranging from about 135 cc/100 g to about 203 cc/100 g; and a compressed oil absorption number (COAN) ranging from about 81 cc/100 g to about 121 cc/100 g.

In a further aspect, the carbon black has at least one of or all of the following properties when in beaded form: a nitrogen surface area (NSA) ranging from about 55 m²/g to about 67 m²/g; a statistical thickness surface area (STSA) ranging from about 50 m²/g to about 61 m²/g; an oil absorption number ranging from about 152 cc/100 g to about 186 cc/100 g; and a compressed oil absorption number (COAN) ranging from about 91 cc/100 g to about 111 cc/100 g.

In a further aspect, the carbon black has at least one of or all of the following properties when in beaded form: a nitrogen surface area (NSA) ranging from about 58 m²/g to about 64 m²/g; a statistical thickness surface area (STSA) ranging from about 52 m²/g to about 58 m²/g; an oil absorption number ranging from about 161 cc/100 g to about 177 cc/100 g; and a compressed oil absorption number (COAN) ranging from about 96 cc/100 g to about 106 cc/100 g.

In some aspects, the carbon black has the following aggregate size distribution: between about 25 weight percent and about 50 weight percent having a particle size less than 400 nm; and between about 40 weight percent and about 65 weight percent having a particle size ranging from 400 nm to 700 nm.

In a further aspect, the carbon black has 325 Mesh Water Residue ranging from about 10 ppm to about 30 ppm. In a further aspect, the carbon black has an ash content of less than about 0.05%. In a still further aspect, the carbon black has sulfur content of less than about 1.5%.

In one aspect, the carbon black can have at least one of the properties listed below in Tables A and B. In some aspect, the carbon black in the polymer composition can exhibit at least the combination of NSA and STSA values listed in Tables A and B. In further aspects, the carbon black in the polymer composition can exhibit at least the combination of NSA, STSA, and OAN values listed in the Tables A and B. In further aspects, the carbon black in the polymer composition can exhibit at least the combination of NSA, STSA, OAN, and COAN values listed in Tables A and B. In further aspects, the carbon black in the polymer composition can exhibit at least the combination of NSA, STSA, OAN, COAN, and 325 Mesh values listed in Tables A and B. In further aspects, the carbon black in the polymer composition can exhibit at least the combination of NSA, STSA, OAN, COAN, 325 Mesh, and ash content values listed in Tables A and B. In further aspects, the carbon black in the polymer composition can exhibit the combination of NSA, STSA, OAN, COAN, 325 Mesh, ash content, and sulfur content values listed in Tables A and B.

TABLE A
Carbon Black Properties in Powdered Form

| | Embodi- | Embodi- | Embodi- | Embodi- |
|---|---|---|---|---|
| | ment | ment | ment | ment (iv) - |
| | (i) | (ii) | (iii) | BCD9110 |
| NSA (m²/g) | 48-72 | 54-66 | 57-63 | 60 |
| STSA (m²/g) | 46-70 | 52-64 | 55-61 | 58 |
| OAN (cc/100 g) | 179-269 | 202-246 | 213-235 | 224 |
| COAN (cc/100 g) | 87-131 | 98-120 | 104-114 | 109 |
| 325 Mesh Water | 22-32 | 24-30 | 26-28 | 27 |
| Residue (ppm) | | | | |
| Ash Content (%) | 0.03-0.05 | 0.04 | 0.04 | 0.04 |
| Sulfur Content | 0.9-1.5 | 1-1.4 | 1-1.3 | 1.23 |
| (%) | | | | |

TABLE B
Carbon Black Properties in Beaded Form

| | Embodi- | Embodi- | Embodi- | Embodi- |
|---|---|---|---|---|
| | ment | ment | ment | ment (iv) - |
| | (i) | (ii) | (iii) | C7055U |
| NSA (m²/g) | 49-73 | 55-67 | 58-64 | 61 |
| STSA (m²/g) | 44-66 | 50-61 | 52-58 | 55 |
| OAN (cc/100 g) | 135-203 | 152-186 | 161-177 | 169 |
| COAN (cc/100 g) | 81-121 | 91-111 | 96-106 | 101 |
| 325 Mesh Water | 10-16 | 12-14 | 12-14 | 13 |
| Residue (ppm) | | | | |
| Ash Content (%) | 0.02 | 0.02 | 0.02 | 0.02 |
| Sulfur Content | 0.4-0.7 | 0.5-0.6 | 0.5-0.6 | 0.54 |
| (%) | | | | |

In one specific aspect, the carbon black can comprise Birla Carbon BCD9110 or BCD911x series carbon black, available from Birla Carbon, Marietta, Georgia USA. In one specific aspect, the carbon black can comprise Birla Carbon BCD9114 carbon black, available from Birla Carbon, Marietta, Georgia USA. In a further aspect, the carbon black can comprise Birla Carbon's CONDUCTEX 7055 Ultra Carbon Black (referred to in this application as “C7055U”). In still other aspects, the carbon black can comprise any other carbon black suitable for use in the present methods.

In another aspect, the carbon black can have a void volume residue at least of 100% under mean pressure of 1 MPa; of 71% under mean pressure of 5 MPa; of 59% under mean pressure of 10 MPa; of 49% under mean pressure of 20 MPa; of 39% under mean pressure of 40 MPa; of 31% under mean pressure of 80 MPa; and/or of 24% under mean pressure of 160 MPa.

In another aspect, the carbon black can have a void volume (V′/V) of about 4.6, as determined by TEM imaging.

In another aspect, the carbon black can be in powder form or in beaded form. In other aspects, the filler can comprise a surface modified carbon black, such as, for example, an oxidized carbon black.

In one aspect, the carbon black can have about 23 wt. % aggregates with sizes greater than about 700 nm, about 35 wt. % aggregates with sizes between about 400 and about 700 nm, and about 42 wt. % aggregates with sizes less than about 400 nm.

In one aspect, the carbon black has the following aggregate size distribution: between about 25 weight percent and about 50 weight percent having a particle size less than 400 nm; and between about 40 weight percent and about 65 weight percent having a particle size ranging from 400 nm to 700 nm.

The amount of carbon black utilized in a particular electrical energy storage or conversion device can vary, e.g., as part of an anode active material. In various aspects, the carbon black loading can be about 5 wt. %, 7 wt. %, 9 wt. %, 11 wt. %, 13 wt. %, 15 wt. %, 17 wt. %, 19 wt. %, 21 wt. %, 23 wt. %, 25 wt. %, 27 wt. %, 29 wt. %, 30 wt. %, 31 wt. %, 33 wt. %, 35 wt. %, 40 wt. %, 45 wt. %, 50 wt. %, 55 wt. %, 60 wt. %, or more. In other aspects, the carbon black loading can be from about 15 wt. % to about 60 wt. %, from about 15 wt. % to about 50 wt. %, from about 15 wt. % to about 40 wt. %, from about 15 wt. % to about 30 wt. %, from about 15 wt. % to about 30 wt. %, from about 18 wt. % to about 30 wt. %, from about 20 wt. % to about 27 wt. %, from about 22 wt. % to about 30 wt. %, or from about 25 wt. % to about 35 wt. %.

In one aspect, the carbon black can be present as a conductive material in or on an electrode. Any suitable method for incorporating the carbon black can be used. For example, the carbon black can be formed into a slurry and after applying the slurry of the conductive composition to a current collector such as an aluminum foil or a copper foil, the solvent can be removed by heating to form an electrode composite layer, which is a porous body in which the active carbon black material is chemically or physically bonded to the surface of the current collector.

In a further aspect, the carbon black can be present in an energy storage or conversion device as a conductive additive or anode active material. In one aspect, the device is a battery or a capacitor. An example of a suitable battery is a lithium-ion battery, e.g., one that comprises an anode, a cathode, and an electrolyte disposed between the anode and the cathode, wherein the anode comprises the carbon black.

The devices of the present invention can be used in a wide range of fields and applications are not particularly limited, but examples include portable AV devices such as digital cameras, video cameras, portable audio players and portable liquid crystal televisions, portable information terminals such as laptop computers, smart phones and mobile PCs, portable game devices, electric power tools, electric bicycles, hybrid vehicles, electric vehicles, electric power storage systems, solar panels, and the like.

### EXAMPLES

Various exemplary embodiments of the invention are detailed below. These embodiments are intended to be exemplary and are not intended to limit the scope of the invention. For each of the following examples, unless indicated to the contrary, the following processes, equipment, and conditions were utilized.

### 1. Example 1

Physical and structural properties of two carbon blacks, Birla Carbon BCD9110 and BCD9114 exhibited the properties shown in Table 1. These carbon blacks can be used in various energy storage and conversion devices, e.g., as a conductive additive or filler of an anode active material.

TABLE 1

| | | BCD9110 | BCD9114 | BCD9114 |
|---|---|---|---|---|
| Test Item | Unit | Sample 1 | Sample 3 | Sample 3 |
| Physical Form | / | Powder | Powder | Bead |
| NSA | m²/g | 60 | 58 | 59 |
| STSA | m²/g | 58 | 57 | 59 |
| OAN | cm³/100 g | 224 | 253 | 199 |
| COAN | cm³/100 g | 109 | — | 112 |
| 325M Residue | ppm | 27 | — | — |
| Ash | % | 0.04 | — | — |
| Sulfur | % | 1.23 | 0.14 | 0.13 |

### 2. Example 2

Physical and structural properties of the two additional inventive carbon blacks are shown in Table 2. As shown, BCD9110 showed significantly higher OAN but only slightly higher COAN than C7055U in powder versus bead form.

TABLE 2

| | | BCD9110 | C7055U |
|---|---|---|---|
| Test Item | Unit | Sample 1 | Sample 4 |
| Physical Form | / | Powder | Bead |
| NSA | m²/g | 60 | 61 |
| STSA | m²/g | 58 | 55 |
| OAN | cm³/100 g | 224 | 169 |
| COAN | cm³/100 g | 109 | 101 |
| 325M Residue | ppm | 27 | 13 |
| Ash | % | 0.04 | 0.02 |
| Sulfur | % | 1.23 | 0.54 |

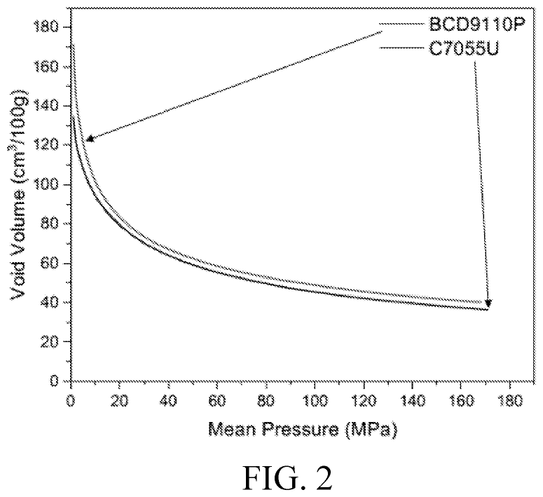

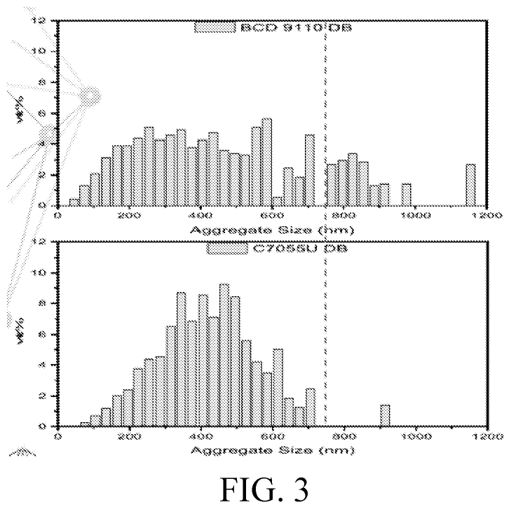

Aggregate sizes of the two carbon blacks are shown below in Table 3. Corresponding plots of aggregate size distribution are shown in FIG. 1. Plots of void volumes are shown in FIG. 2.

It will be apparent to those skilled in the art that various modifications and variations can be made in the present invention without departing from the scope or spirit of the invention. Other embodiments of the invention will be apparent to those skilled in the art from consideration of the specification and practice of the invention disclosed herein. It is intended that the specification and examples be considered as exemplary only, with a true scope and spirit of the invention being indicated by the following claims.

What is claimed is:

1. A carbon black having the following properties when in powdered form:
a) a nitrogen surface area (NS A) ranging from about 45 m2/g to about 75 m2/g; b) a statistical thickness surface area (STSA) ranging from about 45 m2/g to about 75 m2/g;
c) an oil absorption number ranging from about 175 cc/lOOg to about 275 cc/lOOg; and
d) a compressed oil absorption number (COAN) ranging from about 85 cc/lOOg to about 135 cc/lOOg.

2. The carbon black of claim 1, which has the following properties when in powdered form:
a) a nitrogen surface area (NS A) ranging from about 48 m2/g to about 72 m2/g; b) a statistical thickness surface area (STSA) ranging from about 46 m2/g to about 70 m2/g;
c) an oil absorption number ranging from about 179 cc/lOOg to about 269 cc/lOOg; and
d) a compressed oil absorption number (COAN) ranging from about 87 cc/lOOg to about 131 cc/lOOg.

3. The carbon black of claim 1, which has the following properties when in powdered form:
a) a nitrogen surface area (NS A) ranging from about 54 m2/g to about 66 m2/g; b) a statistical thickness surface area (STSA) ranging from about 52 m2/g to about 64 m2/g;
c) an oil absorption number ranging from about 202 cc/lOOg to about 246 cc/lOOg; and
d) a compressed oil absorption number (COAN) ranging from about 98 cc/lOOg to about 120 cc/lOOg.

4. The carbon black of claim 1, which has the following properties when in powdered form:
a) a nitrogen surface area (NSA) ranging from about 57 m2/g to about 63 m2/g; b) a statistical thickness surface area (STSA) ranging from about 55 m2/g to about 61 m2/g;
c) an oil absorption number ranging from about 213 cc/lOOg to about 235 cc/lOOg; and
d) a compressed oil absorption number (COAN) ranging from about 104 cc/lOOg to about 114 cc/lOOg.

5. A carbon black having the following properties when in beaded form:
a) a nitrogen surface area (NSA) ranging from about 45 m2/g to about 75 m2/g; b) a statistical thickness surface area (STSA) ranging from about 40 m2/g to about 75 m2/g;
c) an oil absorption number ranging from about 130 cc/lOOg to about 220 cc/lOOg; and
d) a compressed oil absorption number (COAN) ranging from about 75 cc/lOOg to about 135 cc/lOOg.

6. The carbon black of claim 6, having the following properties when in beaded form:
a) a nitrogen surface area (NSA) ranging from about 49 m2/g to about 73 m2/g; b) a statistical thickness surface area (STSA) ranging from about 44 m2/g to about 66 m2/g;
c) an oil absorption number ranging from about 135 cc/lOOg to about 203 cc/lOOg; and
d) a compressed oil absorption number (COAN) ranging from about 81 cc/lOOg to about 121 cc/lOOg.

7. The carbon black of claim 6, having the following properties when in beaded form:
a) a nitrogen surface area (NSA) ranging from about 55 m2/g to about 67 m2/g; b) a statistical thickness surface area (STSA) ranging from about 50 m2/g to about 61 m2/g;
c) an oil absorption number ranging from about 152 cc/lOOg to about 186 cc/lOOg; and
d) a compressed oil absorption number (COAN) ranging from about 91 cc/lOOg to about 111 cc/lOOg.

8. The carbon black of claim 6, having the following properties when in beaded form:
a) a nitrogen surface area (NSA) ranging from about 58 m2/g to about 64 m2/g; b) a statistical thickness surface area (STSA) ranging from about 52 m2/g to about 58 m2/g;
c) an oil absorption number ranging from about 161 cc/lOOg to about 177 cc/lOOg; and
d) a compressed oil absorption number (COAN) ranging from about 96 cc/lOOg to about 106 cc/lOOg.

9. The carbon black of claim 1, having the following aggregate size distribution:
a) between about 25 weight percent and about 50 weight percent having a particle size less than 400 nm; and
b) between about 40 weight percent and about 65 weight percent having a particle size ranging from 400 nm to 700 nm.

10. The carbon black of claim 1, which has 325 Mesh Water Residue ranging from about 10 ppm to about 30 ppm.

11. The carbon black of claim 1, which has an ash content of less than about 0.05%.

12. The carbon black of claim 1, which has sulfur content of less than about 1.5%.

13. An electrode comprising the carbon black of claim 1.

14. An energy storage or conversion device comprising the carbon black of claim 1 as a conductive additive or anode active material.

15. The energy storage or conversion device of claim 14, which is a battery or a capacitor.

16. The energy storage or conversion device of claim 14, which is a lithium-ion battery.

17. The energy storage or conversion device of claim 16, wherein the lithium-ion battery comprises an anode, a cathode, and an electrolyte disposed between the anode and the cathode, wherein the anode comprises the carbon black.
